(19) United States
(12) Patent Application Publication
(10) Pub. No.: US 2014/0156764 A1
(43) Pub. Date: Jun. 5, 2014

(54) Systems and Methods for the Distribution of Electronic Messages

(71) Applicant: Mike Oliszewski, Tigard, OR (US)

(72) Inventor: Mike Oliszewski, Tigard, OR (US)

(21) Appl. No.: 13/706,327

(22) Filed: Dec. 5, 2012

(51) Int. Cl. H04L 12/58

(52) U.S. Cl. CPC H04L 51/00
USPC 709/206; 707/706; 707/705

(57) ABSTRACT

A system and method for an Enhanced Analog Telephone Adapter (E-ATA) that scans and converts outbound faxes, converts the faxes into a text readable document, and then looks up either a phone and/or fax number(s) in the document and extracts the phone number and cross references this number to an email address. This email address is then used to transmit the document to the destination email address.

### CROSS REFERENCE TO RELATED APPLICATIONS

This application is entitled to a claim of priority for a provisional application No. 61/566,857 filed on Dec. 5, 2011, entitled, “Systems and Methods for the Distribution of Electronic Messages”, by Mike Olizewski, the entire disclosure of which is hereby incorporated by reference as if set forth in its entirety for all purposes.

### BACKGROUND

1. Field of the Invention

This invention relates to computer telephony communications, specifically a method to more efficiently and reliably deliver facsimile documents via electronic mail in general, and by using an Analog Telephone Adapter (ATA) in conjunction with the facsimile documents in particular.

2. Description of the Related Art

The modern computer telephony environment continues to evolve while requiring support for pre-existing devices and mechanisms for processing and transporting large amounts of fax data from location to location in a secure, reliable and efficient manner. The communication of two distant devices and the ability to deliver large amount of legal fax data first existed in the PSTN environment where voice calls were the main consumer and fax or data communication minor consumers.

Even through all of the technological advancements and various forms of moving large amounts of data, the physical process of transmitting large amounts of legal data continues to be with the use of “scan and send” fax devices. Even with the variations of sending faxes without the physical fax machine, every company still has and maintains fax machines for regular use by their employees, customers, and vendors. Even with the increased use of email, ftp, web postings, and other data accessible points the preferred legal means of transmitting large amounts of data via fax remains in high use throughout the world for many years to come.

The last decade has also created a large number of “web searchable” databases that contain information that will allow the mapping of a destination fax number to an email address. These “web searchable” databases are found on any number of social media sites, such as Facebook and/or Linkedin. Similarly, private databases exist that can match an outbound fax number with an email address.

Similarly, there are situations where a person that is sending a fax would like to have a copy of the fax sent by electronic mail to the recipient. For instance, the recipient may not remember or be aware to the recipients email address and at the same time be sending the fax on a public fax machine (e.g. a hotel fax, a library fax, etc.) without the ability to “look up” the email address. Further, the public fax machine may not be located near a computer and/or a scanner.

Improvements in technology have solved the problem with transmission of faxes over IP networks using devices known as Analog Telephone Adapters (ATA's). A typical ATA provides a Fax over IP Connection (FOIP) that eliminates the problem with latency on fax lines. A typical ATA is implemented by AudioCodes in their HTTPS Fax Enabled MP-202B which allows the connection of legacy fax machines to VoIP services. ATA's are typically “black box” services that do not perform any processing on the faxes that are sent and/or received.

Therefore there is a need to provide an improved fax routing system that scans an inbound and/or outbound fax document for telephone numbers, matches those telephone numbers to an external database of electronic mail addresses, and then utilizes those retrieved electronic mail address to forward the scanned document.

### PRIOR ART REFERENCES

The prior art for general fax-to-fax document transmission is well known to those skilled in the art.

Systems for receiving fax transmissions from PSTN and transmitting such documents via electronic mail have been well known in the arts and are supplied by such companies as FaxBack, Inc. (Tualatin, Oreg.). Systems also exist for connection of legacy fax machines to the internet and are well known in the arts.

Prior art for the processing the text on documents received by fax machines is well known in the arts.

### SUMMARY

The present inventive subject matter overcomes problems in the prior art by providing a method of sending a fax document by electronic mail having a fax document is received by and processed by an Enhanced ATA (E-ATA) and converted into an electronic document; storing the FAX as an electronic image processing the FAX image and extracting a set of character data by optical character processing to extract a multiplicity of telephone numbers; cross referencing the extract numbers to an multiplicity of email addresses; creating a new email; attaching the FAX image to an email; and sending the email to a multiplicity of recipients.

The method of sending fax documents by electronic mail, said apparatus further having the method of cross referencing the extract numbers to an multiplicity of email addresses selected from a group having and internal lookup table; a search engine; and a private database.

Also described is an apparatus for sending fax documents by electronic mail, said apparatus having an enhanced ATA; said enhanced ATA with a telephone connection, said telephone connection capable of operating with a fax machine that can communicate with a PSTN network; a data parser, said data parser capable of returned the destination phone number; a cross referencing database, said cross referencing database capable of returning a destination email address; an email agent, said email agent capable of creating and sending an email to the destination email address. The apparatus for sending fax documents by electronic mail, said apparatus further having the ability to extract character data is extracted from the phone number entered on the dial pad. The apparatus for sending fax documents by electronic mail, said apparatus further having the ability to extract character data by OCR from the FAX document and using that character data to determine the email address of the intended recipient by a lookup table.

These and other embodiments are described in more detail in the following detailed descriptions and the figures.

The foregoing is not intended to be an exhaustive list of embodiments and features of the present inventive subject matter. Persons skilled in the art are capable of appreciating other embodiments and features from the following detailed description in conjunction with the drawings.

### BRIEF DESCRIPTION OF THE DRAWINGS

Those skilled in the arts will recognize that the processing of sending a fax may use a dedicated fax machine, a computer system that emulates a fax machine, or an interface through the internet that further emulates a dedicated fax machine. The send fax document may or may not be realized in physical form (e.g. hardcopy).

FIG. 1 shows a prior art diagram of the classic model of fax to fax transmission a PSTN.

FIG. 2 shows a high-level basic diagram of the fax networking system with an ATA.

FIG. 3 shows the high-level basic diagram of the improved fax routing system.

FIG. 4A depicts a flowchart of the preferred embodiment of the improved fax routing system.

FIG. 4B depicts a flowchart of the alternate embodiment of the improved fax routing system.

FIG. 4C is a flowchart of the alternate embodiment for processing the fax document.

FIG. 5 depicts a document flow diagram of the improved fax routing system

### LIST OF REFERENCE CHARACTERS

110 sending fax machine
120 receiving fax machine
130 PSTN
150 send fax document
210 ATA
220 TLS (SSL) Proxy
230 internet
310 inbound fax document
330 PSTN to IP Gateway
360 Enhanced ATA (E-ATA)
430 Optical Character Processing
440 extracted phone numbers
450 email
450a Internal Lookup Table
450b Search Engine
450c Private Database
540 telephone line
570 electronic mail

### DETAILED DESCRIPTION

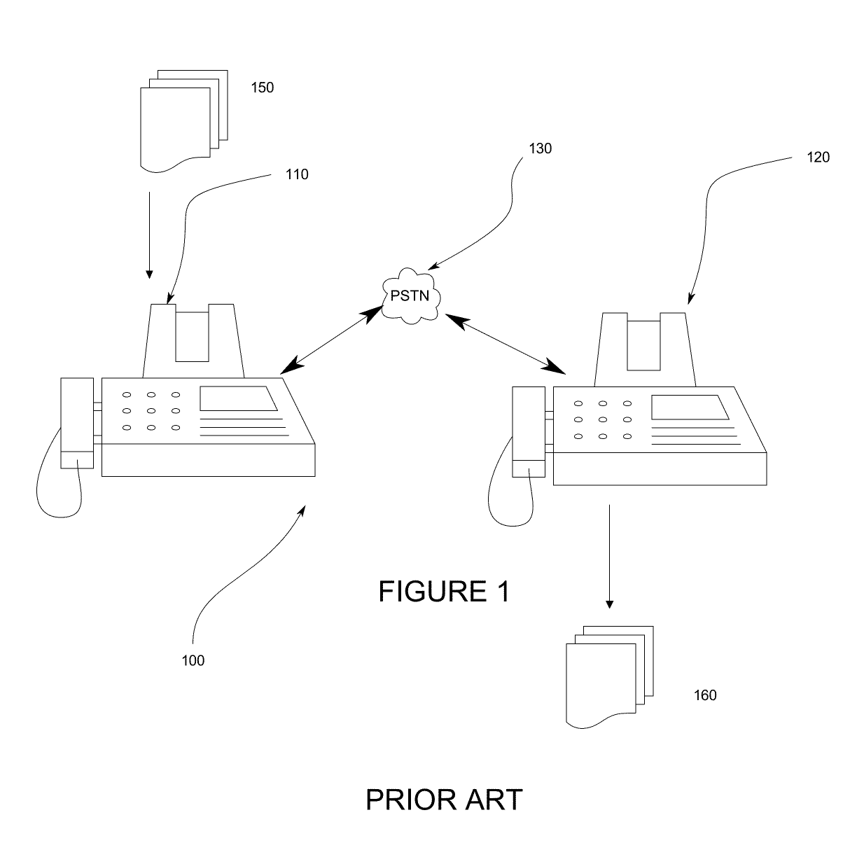

Representative embodiments according to the inventive subject matter are shown in FIGS. 1-5, wherein similar features share common reference numerals.

As shown in FIG. 1, the basic functionality demonstrating the connectivity of a sending fax device 110, through a public switch telephone network PSTN 130, directly connected to the receiving fax device 120. This model represents the legacy point-to-point system transmitting fax data.

Representative embodiments according to the inventive subject matter are shown in FIGS. 1-5, wherein similar features share common reference numerals.

Now referring to FIG. 1 which shows a basic diagram of a typical switched based public telephone network (PSTN) system 100 with a sending fax machine 110 connected to the PSTN 130 (“Public Switched Telephone Network”) which is further connected to the receiving fax machine 120. The method of faxing a document generally consists of inserting a send fax document 150 into the sending fax machine 110. The send fax document 150 is scanned by the sending fax machine 110. The sending fax machine transmits the scanned document to the receiving fax machine 120 which then prints out a received facsimile document 160. Those skilled in the arts will immediately recognize the many variations of this traditional model for sending and receiving faxes, for example, the fax machines can send and receive multiple documents. The documents are sent and received by optical scanning, caching the scanned documents in the memory of the fax machine, and then sending the document from the fax machine memory.

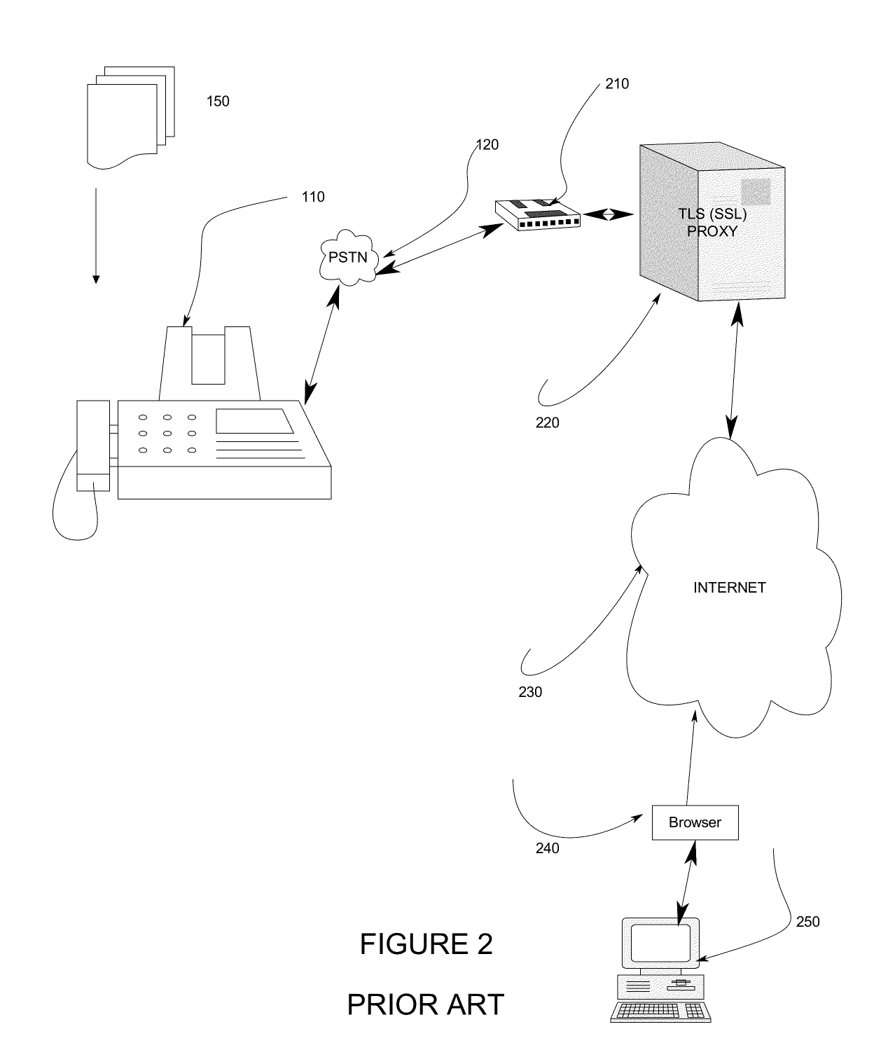

FIG. 2 shows a configuration of the prior art using an ATA 210. The ATA 210 provides a secure and reliable HTTPS connections between a sending fax machine 110 and the internet 230 via a TLS (SSL) Proxy 220. The ATA 210 further emulates the features of a PSTN 130 so that the individual does not experience problems using the fax machine. This ATA 210 “plug compatibility” reduces user installation and operational costs.

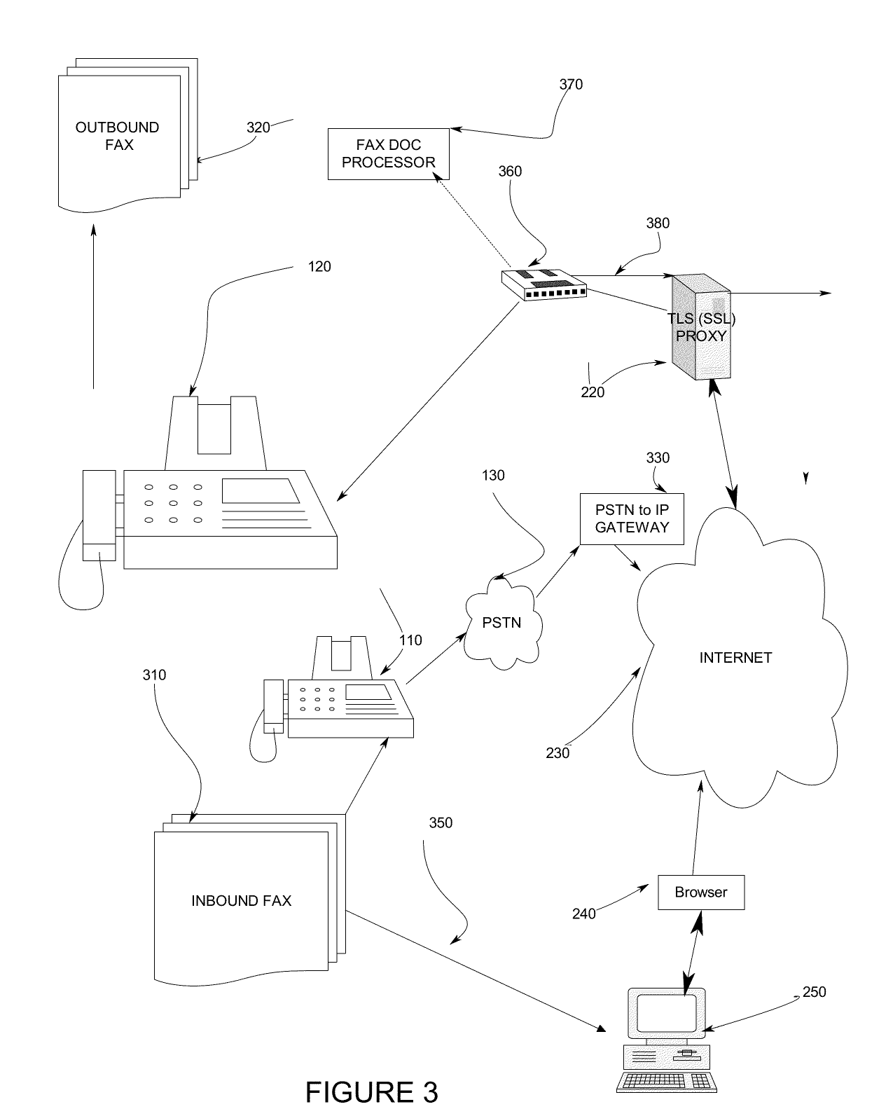

Now referring to FIG. 3 which depicts an embodiment of the inventive subject matter. An inbound fax document 310 is sent via a sending fax machine 110 that is connect to a PSTN 130 which is further connected to the internet 230 via a PSTN to IP Gateway 330. Specific implementations of the PSTN to IP Gateway 330 may consist of a NET SatisFAXtion Enterprise & Multi-site Edition Fax Server System (see http://www.faxback.com/Products/EnterpriseFaxServers.html) connected to a SIP T.38 Compatible Media Gateway.

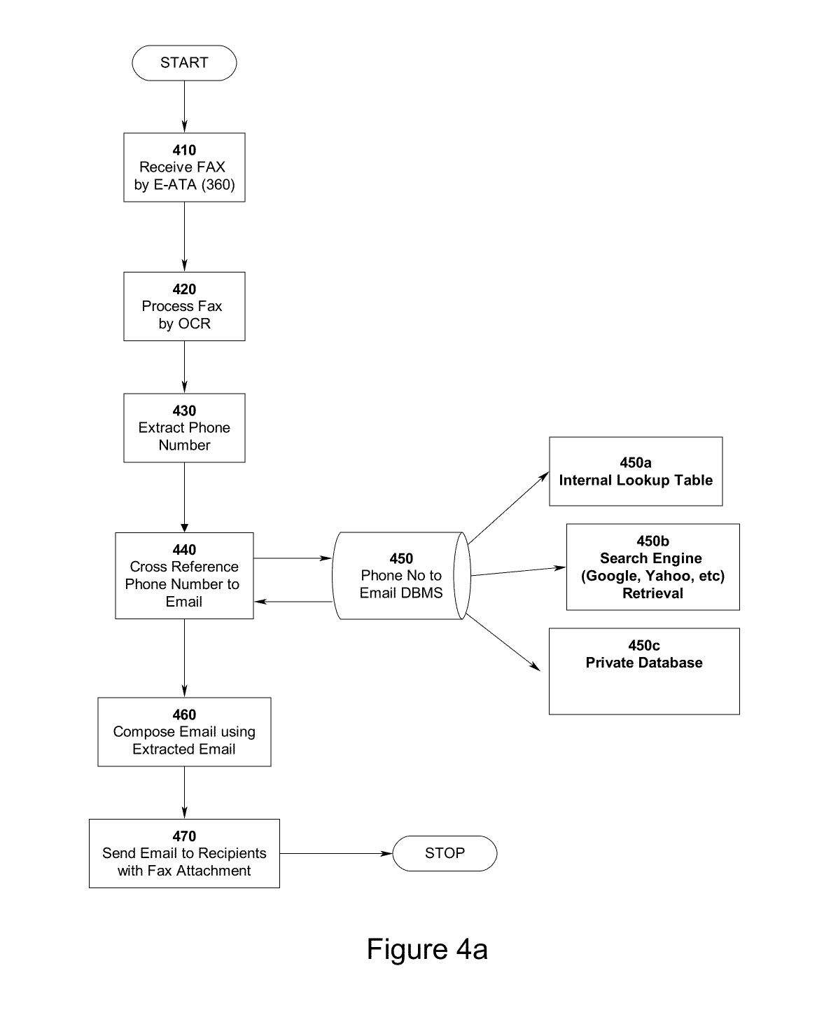

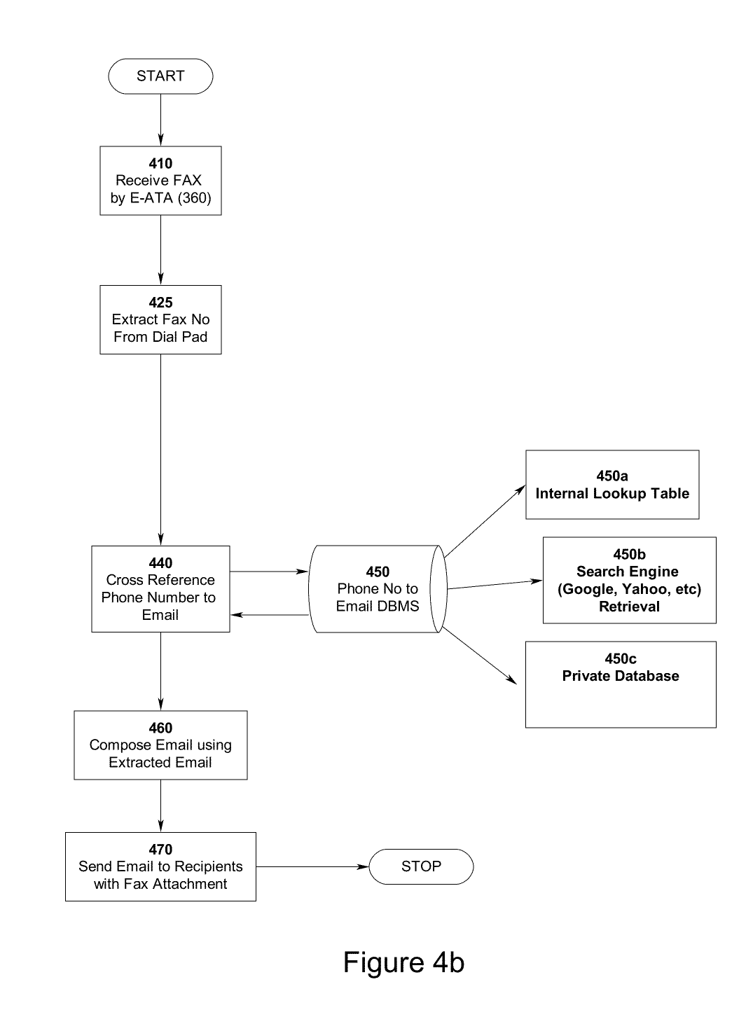

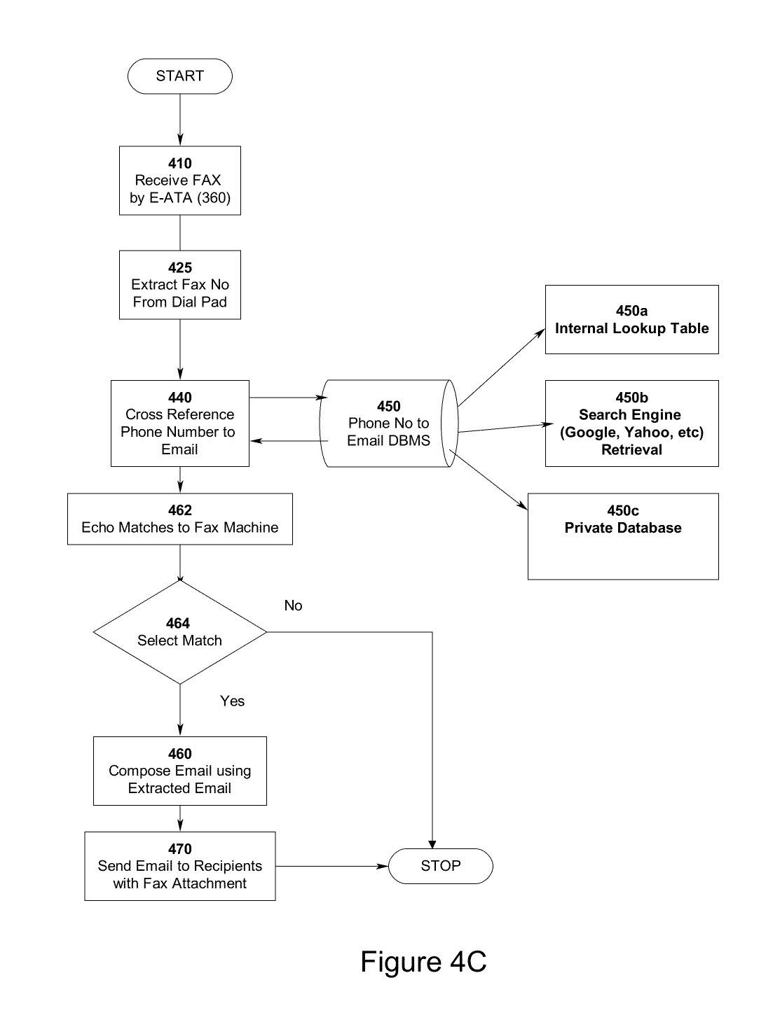

Now referring to FIG. 4A which provides for a method of processing and distributing fax documents 410. The first step in processing 410 is that a fax document is received by and processed by an Enhanced ATA (E-ATA) 360 and converted into an electronic document. The FAX is typically stored as an electronic image document that is any one of a number of standard formats, such as TIFF or PDF. The next processing step 420 consists of the software that can process the FAX image so that character data can be extracted by Optical Character Processing 430. The extracted character data is parsed to locate one or more extracted phone numbers 440. These extracted phone numbers 440 are then cross referenced to an email address 450. Several types of lookup databases can be utilized for the purpose of cross referencing, such as: i) 450a Internal Lookup Table; ii) 450b Search Engine (Google, Yahoo, etc); and iii) from a 450c Private Database.

Now referring to FIG. 4B which refers to an alternate embodiment of the novel method for the distribution of fax documents. The first step in processing 410 is that a fax document is received by and processed by an Enhanced ATA (E-ATA) 360 and converted into an electronic document. The FAX is typically stored as an electronic image document that is any one of a number of standard formats, such as TIFF or PDF. The next processing step 420 consists of the software that can process the FAX image so that character data can be extracted by Optical Character Processing 430. The extracted character data is parsed from the Extracted Phone Number from the Dial Pad 425. The extracted phone numbers 440 are then cross referenced to an email 450. Several types of lookup databases can be utilized, such as: i) 450a Internal Lookup Table; ii) 450b Search Engine (Google, Yahoo, etc); and iii) from a 450c Private Database. The next processing step 460 takes the extracted phone number from the enhanced ATA 360 composes an email with the attached electronic document(s).

Now referring to FIG. 4C which refers to an alternate embodiment first step in processing 410 is that a fax document is received by and processed by an Enhanced ATA (E-ATA) 360 and converted into an electronic document. The FAX is typically stored as an electronic image document that is any one of a number of standard formats, such as TIFF or PDF. The next processing step 420 consists of the software that can process the FAX image so that character data can be extracted by Optical Character Processing 430. The extracted character data is parsed from the Extracted Phone Number from the Dial Pad 425. The extracted phone numbers 440 are then cross referenced to an email 450. Several types of lookup databases can be utilized, such as: i) 450a Internal Lookup Table; ii) 450b Search Engine (Google, Yahoo, etc); and iii) from a 450c Private Database. The next processing step 460 takes the extracted phone number from the enhanced ATA 360 composes an email with the attached electronic document(s). If one or more matches are returned from the cross reference, it is “echoed” to the fax machine in terms of a fax document. The user can then select the match 464 by entering in a number which is “captured” by the ATA. The matched number 464 is then indexed to the extracted email which is used to transfer the document. The next processing step 470 involves the enhanced ATA sending the extracted fax document to recipients with fax attachment as attached to the email.

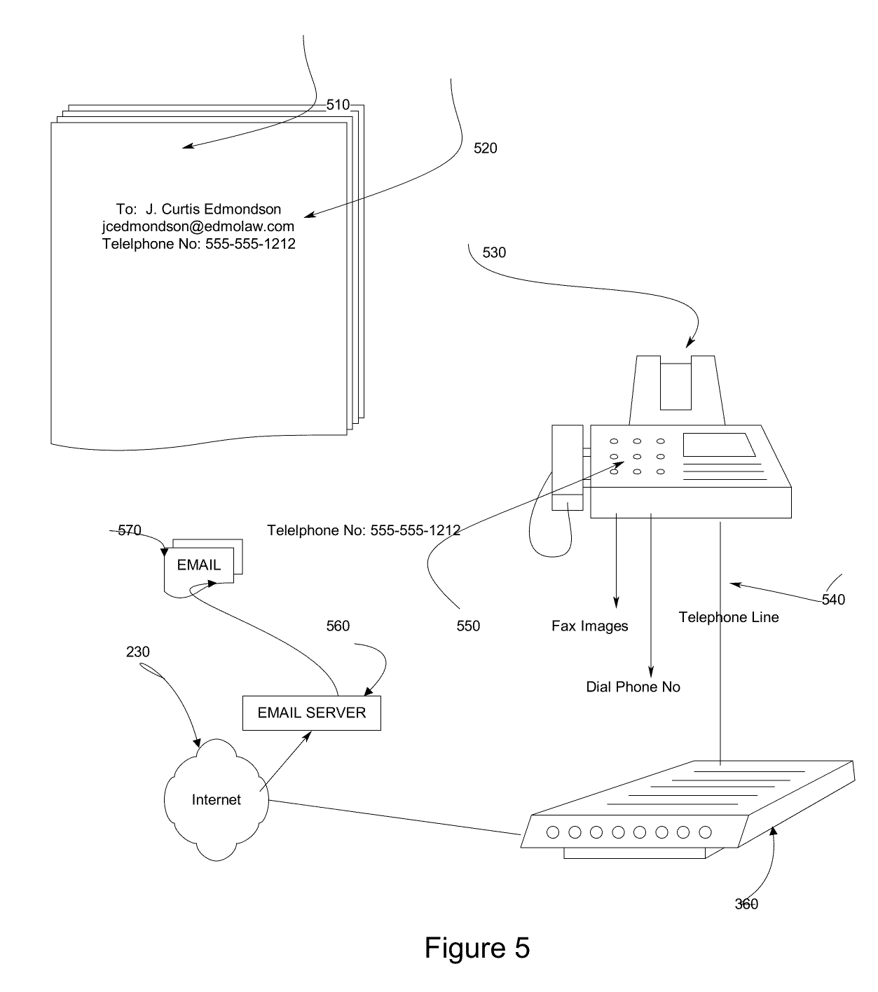

Now referring to FIG. 5 which demonstrates the flow of the facsimile documents to electronic mail documents. The facsimile document 510 contains text which includes and email address 520 and a telephone number. This document is inserted and scanned into the fax machine 530. These documents are transmitted on the telephone line 540 to an Enhanced ATA (E-ATA) 360. The Enhanced ATA (E-ATA) 360 transfers the document to the internet 230 by converting the document to a format appropriate for electronic mail 570.

Persons skilled in the art will recognize that many modifications and variations are possible in the details, materials, and arrangements of the parts and actions which have been described and illustrated in order to explain the nature of this inventive concept and that such modifications and variations do not depart from the spirit and scope of the teachings and claims contained therein.

All patent and non-patent literature cited herein is hereby incorporated by references in its entirety for all purposes.

Persons skilled in the art will recognize that many modifications and variations are possible in the details, materials, and arrangements of the parts and actions which have been described and illustrated in order to explain the nature of this inventive concept and that such modifications and variations do not depart from the spirit and scope of the teachings and claims contained therein.

All patent and non-patent literature cited herein is hereby incorporated by references in its entirety for all purposes.

1. A method of sending a facsimile document by electronic mail comprising the steps of:
receiving a PSTN facsimile transmission by an enhanced analog telephone adapter adaptably connected to an internet protocol gateway;
converting the facsimile transmission into an electronic document;
storing the electronic document as a facsimile image in the database;
processing the facsimile image to extract a multiplicity of telephone numbers from the facsimile image;
cross referencing the telephone numbers to one or more email addresses associated with the telephone numbers;
creating an electronic mail document;
attaching the fascsimile image to the electronic mail document;
sending the electronic mail document to one or more email addresses to a multiplicity of recipients using the internet product gateway;
so that each of the recipients receives the electronic mail document.

2. The method of sending facsimile documents by electronic mail according to claim 1, wherein the apparatus further comprises the steps of:
cross referencing the extracted numbers by using an internal lookup table.

3. The method of sending fax documents by electronic mail according to claim 1, wherein the apparatus further comprises the steps of:
cross referencing the extracted numbers by using an external search engine.

4. The method of sending facsimile documents by electronic mail according to claim 1, wherein the apparatus further comprises
cross referencing the extracted numbers by using a database of email addresses provided by a third party.

5. The method of sending fax documents by electronic mail according to claim 1, wherein the enhanced analog telephone adapter is adaptably connected to an internet protocol gateway via a TLS or SSL proxy.

6. The method of sending facsimile documents by electronic mail according to claim 1, wherein the apparatus further comprises the steps of:
transmitting a list of the extracted email addresses to the enhanced telephone adapter;
displaying the list of the extracted email address on the enhanced telephone adapter;
providing for the selection of an extracted email address from the list of the extracted email addresses by the enhanced telephone adapter;
using the extracted email address by the enhanced telephone adapter as the email address associated with the telephone number.

7. A apparatus for converting facsimile documents into an electronic mail comprising:
an enhanced analog telephone adapter having a public switched telephone network interface, a controller connected to the public switched telephone network interface, and an internet connection connected to the controller;
the controller further comprising:
a means for receiving and storing a facsimile document from the public switched telephone network interface,
a means for the extraction from the facsimile document one or more telephone numbers from the facsimile document;
a means for matching the telephone numbers to one or more electronic mail addresses;
a means for the creation of an electronic mail with an electronic mail address;
a means for sending the electronic mail with the facsimile document;
such that an electronic mail is received, converted, attached and electronically mailed by the enhanced analog telephone adapter.
